(19) United States
(12) Patent Application Publication
(10) Pub. No.: US 2009/0058503 A1
(43) Pub. Date: Mar. 5, 2009

(54) Method to Bridge a Distance Between eFuse Banks That Contain Encoded Data

(76) Inventors: Michael Joseph Genden, Austin, TX (US); Mack Wayne Riley, Austin, TX (US)

Correspondence Address: HAMILTON & TERRILE, LLP;IBM Austin, P.O. BOX 203518, AUSTIN, TX, 78720, US

(21) Appl. No.: 11/847,390

(22) Filed: Aug. 30, 2007

(51) Int. Cl. H01H 37/76

(52) U.S. Cl. 327/525

(57) ABSTRACT

An eFuse system that includes a mechanism that bridges banks of eFuses and allows the banks of eFuses to be placed any distance from each other. The bridging of the eFuse banks is transparent to compression and encode programming algorithm and hardware decode mechanisms. Thus, by using the mechanism for bridging gaps between eFuse banks, an eFuse subsystem with several banks distributed on an integrated circuit chip appears to be a single large eFuse bank to the encode/decode mechanisms of the integrated circuit. Additionally, with this mechanism, eFuse banks can be easily added or deleted.

### BACKGROUND OF THE INVENTION

1. Field of the Invention

The present invention relates in general to the field of computers and similar technologies, and in particular to integrated circuits utilized in this field. Still more particularly, the present invention relates to electronically programmable fuse banks that contain encoded data.

2. Description of the Related Art

With continued scaling in semiconductor technologies to increasingly smaller geometries, on-chip electronically programmable fuse (eFuse) implementations provide an attractive alternative to conventional fusing schemes for integrated circuits. In terms of area efficiency and performance impact, eFuse technology presents a significant improvement over fuse technologies with optical based programming. Programmable devices for integrated circuits can often require a dependable methodology for customizing a device in a repeatable and reliable manner. Fusing of programmable connections in microprocessors, FPGAs and other VLSI designs is a common technique to achieve the flexibility of programmability.

An eFuse device fabricated in silicon-based integrated circuits is typically programmed using a large voltage, relative to the operating voltage of the integrated circuit, to melt and separate the fuse body material. This process changes the fuse material from a low resistance to a high resistance, which may be measured by “sensing” circuitry to determine whether the eFuse has been programmed.

eFuses are generally clustered in a group (also referred to as a bank) due to their unique voltage requirements. Data stored in these eFuses can be compressed or encoded to reduce the number of efuses needed by an application. When multiple banks of efuses are used, the most efficient method of communication from bank to bank is via a scan interface.

With multi-gigahertz interfaces, an issue for eFuses relates to staging latches. If the staging latches are free running, repeated starting and stopping of the shifting of data may not be easily performed without losing data. If the staging latches are gated to start and stop in step with the efuse latches, the encode algorithm and the decode algorithm need to be aware of the number of staging latches and account for any gaps in the data on startup. Techniques exist to provide gating mechanisms, which can often be complex, to bridge between efuse banks. However, adding such gating mechanisms can make it difficult to increase or decrease the number of efuses from design to design.

Accordingly, it is desired to provide a method for bridging gaps between eFuse banks with no impact to the encode algorithms and decode hardware.

### SUMMARY OF THE INVENTION

In accordance with the present invention, an eFuse system is set forth which includes a mechanism that bridges banks of efuses and allows the banks of eFuses to be placed any distance from each other. The bridging of the efuse banks is transparent to compression and encode programming algorithms and hardware decode mechanisms. Thus, by using the mechanism for bridging gaps between eFuse banks, an eFuse subsystem with several banks distributed on an integrated circuit chip appears to be a single large efuse bank to the encode/decode mechanisms of the integrated circuit. Additionally, with this mechanism, eFuse banks can be easily added or deleted.

More specifically, in one embodiment, the invention relates to an electronic fuse (eFuse) apparatus comprising a first eFuse subsystem, a second eFuse subsystem and a staging circuit coupled between the first eFuse subsystem and the second eFuse subsystem. The second eFuse subsystem is physically separate from the first eFuse subsystem and includes an eFuse bridge that provides a parallel latch staging signal. The staging circuit receives the parallel latch staging signal. The staging latch prestaging is based upon the parallel latch staging signal.

In another embodiment, the invention relates to a method for bridging physically separate banks of electronic fuses (eFuses) by providing a staging circuit between the physically separate banks of eFuses, generating a parallel latch staging signal from a down stage eFuse bank, receiving the parallel latch staging signal at the staging circuit, and prestaging the staging circuit based upon the parallel latch staging signal.

In another embodiment, the invention relates to a data processing system that includes an electronic fuse (eFuse) system. The eFuse system includes a first eFuse subsystem, a second eFuse subsystem, and a staging circuit coupled between the first eFuse subsystem and the second eFuse subsystem. The second eFuse subsystem is physically separate from the first eFuse subsystem and includes an eFuse bridge that provides a parallel latch staging signal. The staging circuit receives the parallel latch staging signal. The staging latch prestaging is based upon the parallel latch staging signal.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 shows a block diagram of an electronically programmable fuse bank implementation.

FIG. 2 shows a block diagram of a 4-bit eFuse bridge macro.

FIG. 3 shows a block diagram of program solution path of a bridge portion of an eFuse system.

FIG. 4 shows a block diagram of a program solution programming mode of a bridge portion of an eFuse system.

FIG. 5 shows a block diagram of a data processing system suitable for practicing embodiments of the present invention.

### DETAILED DESCRIPTION

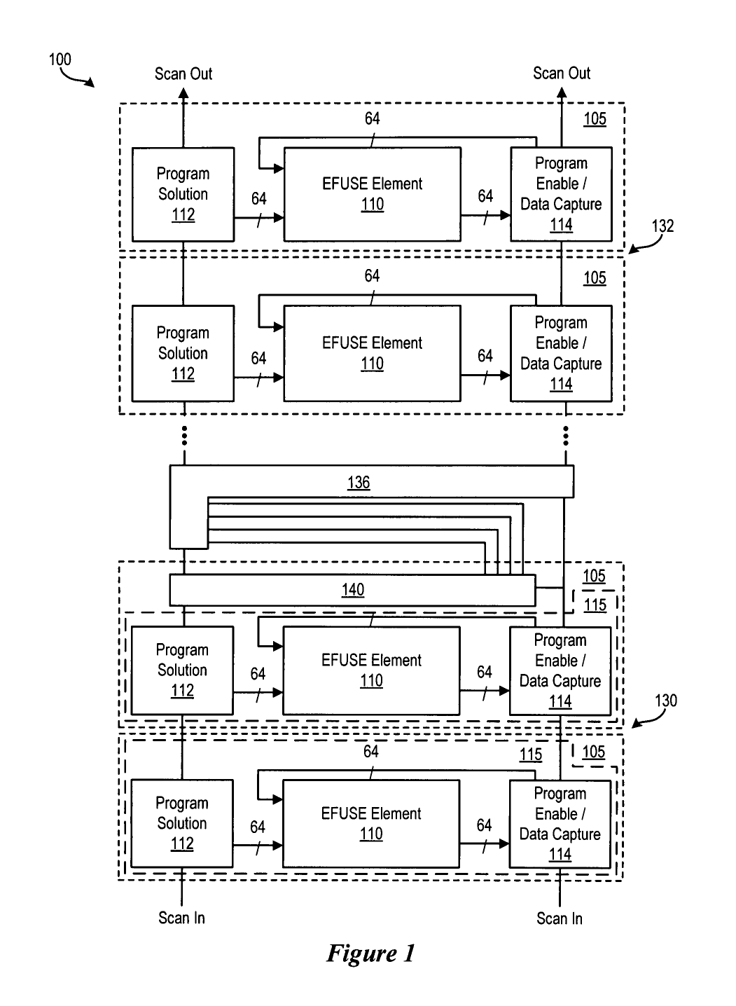

Referring to FIG. 1, an eFuse system 100 is shown. The eFuse system 100 comprises a plurality of eFuse macros 105. In one embodiment, each eFuse macro 105 comprises a 64-bit eFuse element 110 as well as a respective programming solution 64-bit latch 112 and a 64-bit program enable/data capture latch 114. The combination of the eFuse element 110, the program solution latch 112 and the program enable data capture latch 114 provides an eFuse subsystem 115. When programming an eFuse element 110, data is serially scanned into the corresponding programming solution latch 112. Once loaded, the parallel outputs of the latch 112 are used to provide program data to the eFuse element 110. The programming enable latch 114 is serially scanned to provide the necessary controls to program a corresponding eFuse element 110 within the eFuse system 100.

The programming enable latch 114 provides a dual use function. More specifically, the programming enable latch 114 provides the programming function and is also used to capture the data supplied by the eFuse element 110 on an eFuse data read operation. When a read operation occurs to the eFuse element 110, the data is captured via a parallel port of the programming enable latch 114.

In certain integrated circuit designs, it is not possible to place all the eFuse macros 105 in one location (i.e., in physically contiguous locations). For these instances, the eFuse system 100 is divided into multiple banks; e.g., eFuse bank 130 and eFuse bank 132, each comprising one or more macros 105. The physically separate banks are coupled via an eFuse staging circuit 136 and a bridge circuit 140 (which is included within the down stage macro). Thus, the down stage macro 105 includes a bridge circuit 140 and an eFuse subsystem 115. To communicate to each of the physically separate banks 130, 132, the communication paths between the banks are extended to compensate for the banks not being physically contiguous. Each eFuse macro includes serial and parallel data outputs.

The eFuse system 100 may include any number of eFuse macros based upon an integrated circuit design. For example, if an integrated circuit is designed with 2048 eFuses, 32 64-bit eFuse macros are connected to provide the eFuse system 100. These macros may be connected as physically contiguous macros or as physically separate macros. When the macros are physically separate, the down stage macro includes a bridge macro 140 and the eFuse subsystems are coupled via a staging circuit 136.

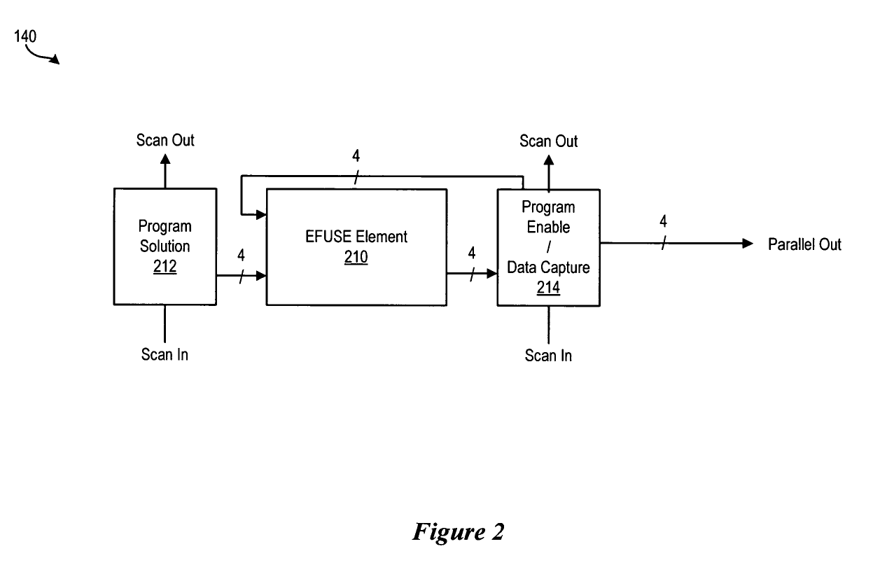

Referring to FIG. 2, a block diagram of a 4-bit bridge circuit 140 is shown. In one embodiment, the bridge circuit 140 includes a 4-bit eFuse element 210 as well as a 4-bit program solution latch 212 and a 4-bit program enable and data capture latch 214.

The 4-bit eFuse circuit 140 includes the attributes of the 64-bit eFuse elements, but also provides a 4-bit parallel latch staging signal output. The parallel latch staging signal output is used to eliminate the staging problem that can occur when the eFuse banks are physically separate.

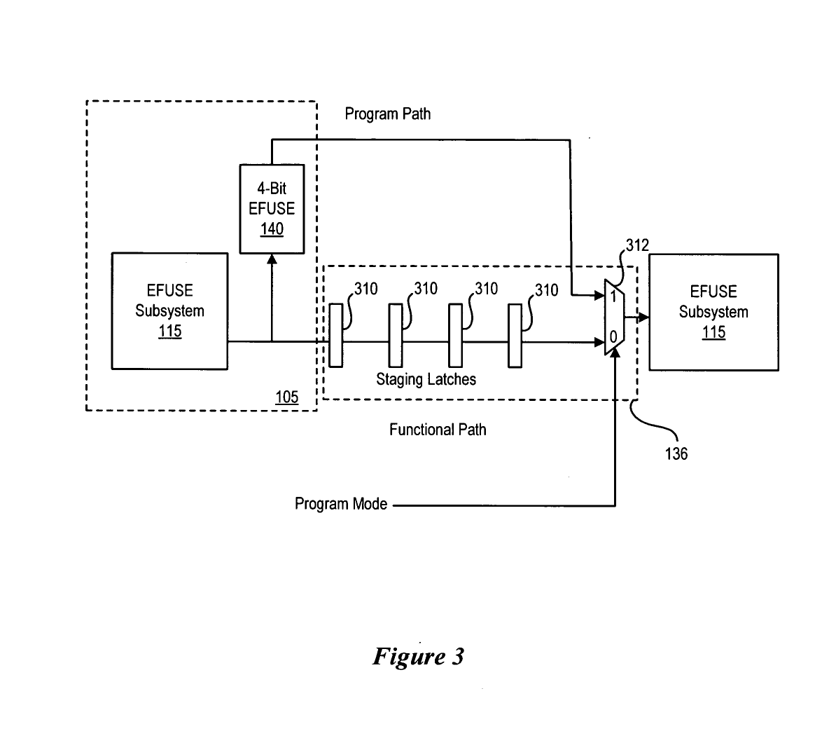

FIG. 3 shows a block diagram of the program solution path of a bridge portion of an eFuse system. When the eFuse macros 105 are located at different (i.e., physically separate) locations within an integrated circuit, the eFuse macros 105 are connected serially. To program the eFuse system 100, the program mode signal is activated.

When programming the eFuse elements within the macros 105, the latches 310 are bypassed. eFuse programming is performed with slow clock rates. During a programming operation, the program mode signal is set to active. Setting the program mode signal causes the multiplexer 312 to select the serial path through the 4-bit eFuse. Because timing is not an issue during programming due to the relatively slow clock rates, this is a straightforward path (shown as program path in FIG. 3). The path from the 4-bit eFuse is simply buffered to meet slew requirements for connecting to the next eFuse bank.

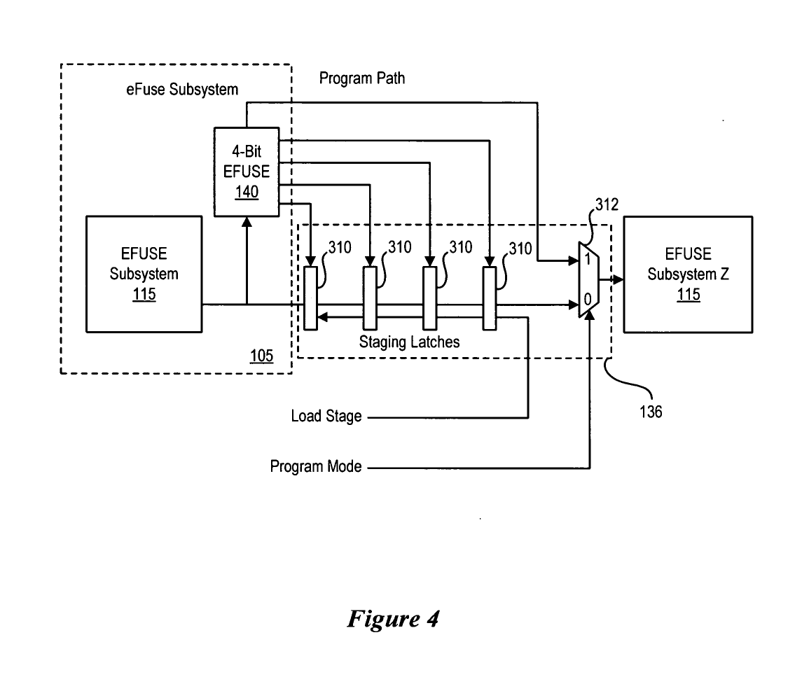

FIG. 4 shows the block diagram of an eFuse bridge when operated in functional mode. For the functional mode, the Program Mode signal is inactive. This causes the multiplexer 312 to select the data path through the staging latches.

Using the bridging circuit 140 eliminates problems associated with staging latches alone for the data capture side of the eFuse subsystem. The 4-bit eFuse bridge circuit 140 is added to the sourcing eFuse bank that sends data to the next (physically separate) eFuse bank. The parallel outputs of the 4-bit eFuse bridge circuit 140 are coupled to respective parallel ports of four staging latches 310 included within the staging circuit 136. During the eFuse read operation, valid data will be presented on the parallel outputs of the 4-bit eFuse bridge circuit 140. Following the eFuse read, the Load Stage signal will be pulsed to cause the output data from the 4-bit eFuse bridge to be stored in the staging latches 310. This action causes valid data to be placed in the staging latches 310 to eliminate potential data gaps that could be caused by the staging latches.

During functional operation, data is shifted between eFuse macros 105 at multi-gigahertz clock rates. Clock controls of the staging latches 310 are the same as the eFuse latches for serial shifting. The staging latches 310 are used for functional (high-speed) transfers. The signal load stage allows data to be loaded from the functional data port of the staging latch 310. The serial output of the 4-bit eFuse bridge circuit 140 is coupled to the input of a multiplexer 312 of the bridge circuit 136. Multiplexer 312 supports both the slow path needed for programming and the high-speed path needed for functional operation of the eFuses.

For function mode, the eFuse scan can operate at multi-Gigahertz clock rates. During the function mode, the program mode signal is set low, thus selecting the path through the staging latches 310. When a read of the eFuses occurs, the value in the eFuse is latched in the data capture latches and propagated to the parallel data input of the staging latches 310. At the transition of the load stage signal, the staging latches 310 capture the contents of the 4-bit eFuse bridge circuit 140. The time between the read of the eFuses and the activation for the load stage signal is relatively long (e.g., 100's of milliseconds). So the parallel data outputs of the 4-bit eFuse circuit 140 are simply buffered to meet slew rates. After the eFuse data is loaded into the staging latches 310, the data is now positioned to shift at full clock rate and thus eliminates any data gaps between the eFuse banks due to the eFuse banks being physically separate.

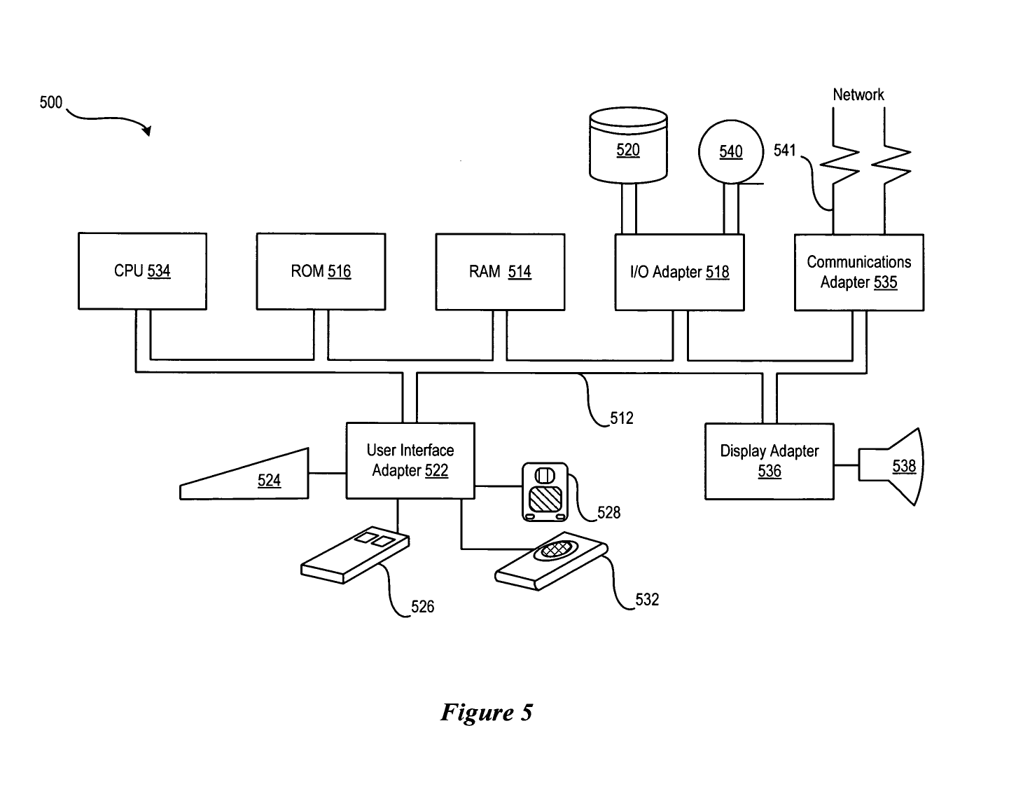

FIG. 5 is a high level functional block diagram of a representative data processing system 500 suitable for practicing the principles of the present invention. Data processing system 500 includes a central processing system (CPU) 510 operating in conjunction with a system bus 512. System bus 512 operates in accordance with a standard bus protocol, such as the ISA protocol, compatible with CPU 534. CPU 534 operates in conjunction with electronically erasable programmable read-only memory (EEPROM) 516 and random access memory (RAM) 514. Among other things, EEPROM 516 supports storage of the Basic Input Output System (BIOS) data and recovery code. RAM 514 includes DRAM (Dynamic Random Access Memory) system memory and SRAM (Static Random Access Memory) external cache. I/O Adapter 518 allows for an interconnection between the devices on system bus 512 and external peripherals, such as mass storage devices (e.g., a hard drive, floppy drive or CD/ROM drive), or a printer 540. A peripheral device 520 is, for example, coupled to a peripheral control interface (PCI) bus, and I/O adapter 518 therefore may be a PCI bus bridge. User interface adapter 522 couples various user input devices, such as a keyboard 524 or mouse 526 to the processing devices on bus 512. Display 538 which may be, for example, cathode ray tubes (CRT), liquid crystal display (LCD) or similar conventional display units. Display adapter 536 may include, among other things, a conventional display controller and frame buffer memory. Data processing system 500 may be selectively coupled to a computer or telecommunications network 541 through communications adapter 534. Communications adapter 534 may include, for example, a modem for connection to a telecom network and/or hardware and software for connecting to a computer network such as a local area network (LAN) or a wide area network (WAN). CPU 534 and other components of data processing system 500 may contain DLL circuitry for local generation of clocks wherein the DLL circuitry employs a phase detector according to embodiments of the present invention to conserve power and to reduce phase jitter. A phase detector in accordance with the present invention may be found within a variety of elements within the data processing system.

Although the present invention and its advantages have been described in detail, it should be understood that various changes, substitutions and alterations can be made herein without departing from the spirit and scope of the invention as defined by the appended claims.

For example, it will be appreciated that while the eFuse system 100 is shown with four 64-bit eFuse macros, other numbers of macros and other bit widths are within the scope of the invention. In addition, it will be appreciated that other combinations of physically contiguous and physically separate eFuse macros are within the scope of the invention. Also, it will be appreciated that while the bridge macro is shown with a 4-bit eFuse element, other width eFuses are within the scope of the invention. Also, it will be appreciated that the staging circuit may include any number of staging latches.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

As will be appreciated by one skilled in the art, while the present invention, and circuits within the present invention are described using certain combinations of logic, other logic combinations are also within the scope of the invention. For example, it will be appreciated other logic combinations to provide a staging circuit are known. Also, it will be appreciated that changing the polarity of the logic gates, e.g., from AND gates to NAND gates, are within the scope of the invention.

The block diagrams in the Figures illustrate the architecture, functionality, and operation of possible implementations of systems and methods according to various embodiments of the present invention. It will also be noted that each block of the block diagrams, and combinations of blocks in the block diagrams, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. An electronic fuse (eFuse) apparatus comprising
a first eFuse subsystem;
a second eFuse subsystem, the second eFuse subsystem being physically separate from the first eFuse subsystem, the second eFuse subsystem including an eFuse bridge, the eFuse bridge providing a parallel latch staging signal; and,
a staging circuit coupled between the first eFuse subsystem and the second eFuse subsystem, the staging circuit receiving the parallel latch staging signal, the staging circuit prestaging based upon the parallel latch staging signal.

2. The eFuse apparatus of claim 1 wherein the eFuse bridge comprises:
a program solution latch;
a multi-bit eFuse element; and,
a program enable and data capture latch circuit, the program enable and data capture circuit providing the parallel latch staging signal based upon contents of the eFuse element.

3. The eFuse apparatus of claim 1 wherein the staging circuit comprises:
a plurality of staging latches; and,
a multiplexer.

4. The eFuse apparatus of claim 3 wherein:
the plurality of staging latches correspond to respective bits of the parallel latch staging signal.

5. The eFuse apparatus of claim 3 wherein:
the multiplexer receives a program mode signal, the program mode signal controlling whether the multiplexer selects a serial path through the plurality of staging latches.

6. A method for bridging physically separate banks of electronic fuses (eFuses) comprising:
providing a staging circuit between the physically separate banks of eFuses;
generating a parallel latch staging signal from a down stage eFuse bank;
receiving the parallel latch staging signal at the staging circuit; and,
prestaging the staging circuit based upon the parallel latch staging signal.

7. The method of claim 6 wherein:
the down stage eFuse bank comprises an eFuse bridging circuit, the eFuse bridging circuit generating the parallel latch staging signal.

8. The method of claim 7 wherein the eFuse bridging circuit comprises:
a program solution latch;
a multi-bit eFuse element; and,
a program enable and data capture latch circuit, the program enable and data capture circuit providing the parallel latch staging signal based upon contents of the eFuse element.

9. The method of claim 6 wherein the staging circuit comprises:
a plurality of staging latches; and,
a multiplexer,

10. The method of claim 9 wherein:
the plurality of staging latches correspond to respective bits of the parallel latch staging signal.

11. The method of claim 9 wherein:
the multiplexer receives a program mode signal, the program mode signal controlling whether the multiplexer selects a serial path through the plurality of staging latches.

12. A data processing system comprising:
an electronic fuse (eFuse) system comprising
a first eFuse subsystem;
a second eFuse subsystem, the second eFuse subsystem being physically separate from the first eFuse subsystem, the second eFuse subsystem including an eFuse bridge, the eFuse bridge providing a parallel latch staging signal; and,
a staging circuit coupled between the first eFuse subsystem and the second eFuse subsystem, the staging circuit receiving the parallel latch staging signal, the staging latch prestaging based upon the parallel latch staging signal.

13. The data processing system of claim 12 wherein the eFuse bridge comprises:
a program solution latch;
a multi-bit eFuse element; and,
a program enable and data capture latch circuit, the program enable and data capture circuit providing the parallel latch staging signal based upon contents of the eFuse element.

14. The data processing system of claim 12 wherein the staging circuit comprises:
a plurality of staging latches; and,
a multiplexer,

15. The data processing system of claim 14 wherein:
the plurality of staging latches correspond to respective bits of the parallel latch staging signal.

16. The data processing system of claim 14 wherein:
the multiplexer receives a program mode signal, the program mode signal controlling whether the multiplexer selects a serial path through the plurality of staging latches.
